(19) United States
(12) Patent Application Publication
(10) Pub. No.: US 2007/0058239 A1
(43) Pub. Date: Mar. 15, 2007

(54) Projection lens unit

(75) Inventors: Yasuhiro Sekine, Sano-shi (JP); Takeki Nakada, Sano-shi (JP)

Correspondence Address: BACON & THOMAS, PLLC, 625 SLATERS LANE, FOURTH FLOOR, ALEXANDRIA, VA, 22314, US

(73) Assignee: SEKINOS CO., LTD., Sano-shi (JP)

(21) Appl. No.: 11/519,020

(22) Filed: Sep. 12, 2006

(30) Foreign Application Priority Data
Sep. 13, 2005 (JP) 2005-265910

(51) Int. Cl. G02B 26/00

(52) U.S. Cl. 359/291

(57) ABSTRACT

The setting distance between a DMD element and a projection lens is maintained accurately to display a high-quality image on a screen or the like. A projection lens unit is one in which light from a light source lamp side is reflected on the DMD element as image light and is subsequently projected at a projection lens. The projection lens unit includes a coupling tool that fixes the DMD element and the projection lens integrally in a state where the distance therebetween is accurately supported to a set value. The coupling tool has a color wheel fitting portion positioning and supporting a color wheel, a relay lens fitting portion positioning and supporting a relay lens, a reflection mirror fitting portion positioning and supporting a reflection mirror, a DMD element mounting portion in which the DMD element is mounted and supported, and a projection lens portion in which the projection lens is mounted and supported.

### CROSS-REFERENCE TO RELATED APPLICATION

This application claims, under 35 USC 119, priority of Japanese Application No. 2005-265910 filed Sep. 13, 2005.

### BACKGROUND OF THE INVENTION

The present invention relates to a projection lens unit suitable for use in a rear projector and a front projector adopting DLP (Digital Light Processing).

In recent years, there has been a demand for stable quality (image quality) of a projection image in rear projectors and front projectors along with a trend of high-definition images such as Hi-Vision images. Accordingly, a projection lens unit is also required to have high performance.

In the rear projector adopting the DLP, the distance between a projection lens and a DMD (Digital Micromirror Device) element needs to be set accurately. In general, a projection lens unit including the projection lens and the DMD element is configured as shown in FIG. 2. The projection lens unit comprises a projection lens 1, a DMD element 2, a metal plate 3, a substrate 4, and a lens base 5.

The projection lens 1 is a lens that projects an image reflected on each mirror on the DMD element 2 onto a screen (not shown) or the like. The DMD element 2 is an element having a number of mirrors each of which turns in accordance with image data to create an image. The metal plate 3 is a member to support the DMD element 2. The substrate 4 is a member that supports the DMD element 2 and the metal plate 3 and is equipped with an electric circuit such as a driving circuit, a fan, a heat sink, etc. The lens base 5 is a member which positions the distance (back focus) between the projection lens 1 and the DMD element 2 accurately and supports them.

Under such configuration, light from a light source is selectively reflected on each mirror on the DMD element 2 toward the projection lens 1 side, and an image is projected onto the screen or the like.

Meanwhile, in the above projection lens unit, the projection lens 1 and the DMD element 2 are positioned accurately by the lens base 5. However, along with a trend of high-definition images, higher accuracy in the distance between the projection lens 1 and the DMD element 2 is required.

However, in the case where the projection lens 1 and the DMD element 2 are structurally separated and are coupled by the lens base 5 when they are assembled, variation (displacement of the central axis or tilting) may occur in the distance between the projection lens 1 and the DMD element 2 due to errors at the time of assembling or dimensional accuracy of the metal plate 3 and the lens base 5. Although such variation caused no problem in the past because it is subtle, a problem in which the above variation causes unstable image quality has occurred along with a trend of high-definition images.

### BRIEF SUMMARY OF THE INVENTION

It is an object of the present invention to provide a projection lens unit that supports the DMD element and the above projection lens accurately to prevent unstable image quality even under a trend of the high-definition images. To achieve the object, a projection lens unit according to the present invention is a projection lens unit in which light from a light source side is reflected on a DMD element as image light and is subsequently projected at a projection lens, and comprises a coupling tool that fixes the DMD element and the projection lens integrally in a state where the distance therebetween is accurately supported to a set value.

With this configuration, the DMD element and the projection lens are supported accurately to prevent unstable image quality even under a trend of the high-definition images.

Also, the coupling tool is preferably configured to have a tubular member that encloses the projection lens and is mounted integrally.

With this configuration, by supporting the DMD element and the projection lens by the tubular member with a set distance therebetween, the set distance between the DMD element and the projection lens can be maintained accurately.

Since the set distance between the DMD element and the projection lens can be maintained accurately, a high-quality image can be projected onto a screen or the like.

### BRIEF DESCRIPTION OF THE DRAWINGS

FIG. 1 is a perspective view showing the mounting structure of each optical element of a projection lens unit according to a first embodiment of the present invention.

FIG. 2 is a side view showing a coupling tool that supports a DMD element and a projection lens of a conventional projection lens unit.

FIG. 3 is a schematic block diagram showing the arrangement state of each optical element of the projection lens unit according to the first embodiment of the present invention.

FIG. 4 is a schematic perspective view showing the arrangement state of each optical element of the projection lens unit according to the first embodiment of the present invention.

FIG. 5 is a perspective view showing a coupling tool of the projection lens unit according to the first embodiment of the present invention.

FIG. 6 is a perspective view showing a state in which each optical element is mounted in the coupling tool of the projection lens unit according to the first embodiment of the present invention.

FIG. 7 is a schematic block diagram showing the arrangement state of each optical element of the projection lens unit according to a second embodiment of the present invention.

FIG. 8 is a schematic block diagram showing the arrangement state of each optical element of the projection lens unit according to a third embodiment of the present invention.

### DESCRIPTION OF THE PREFERRED EMBODIMENTS

### First Embodiment

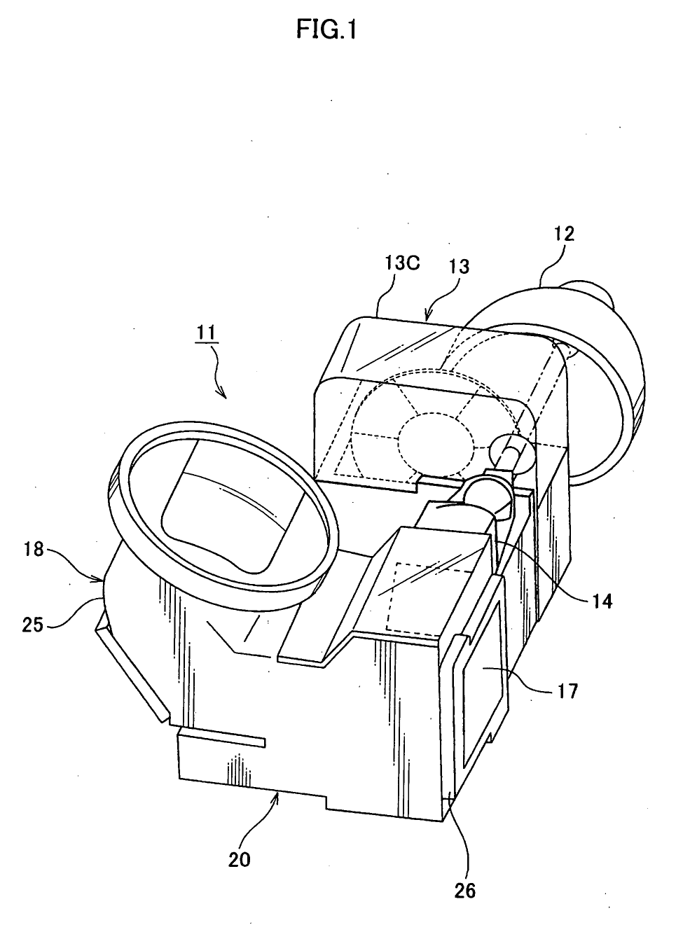

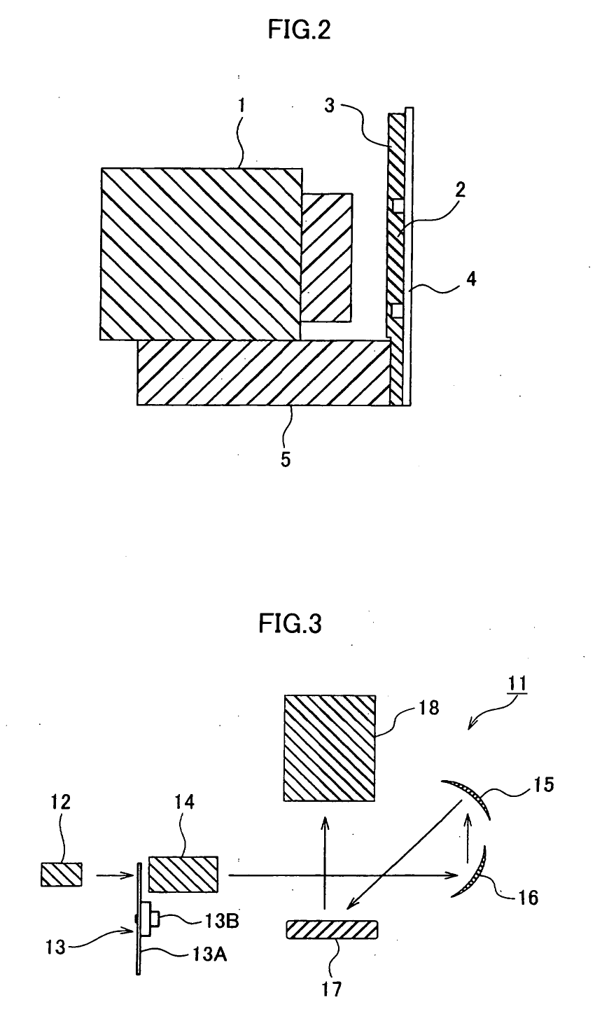

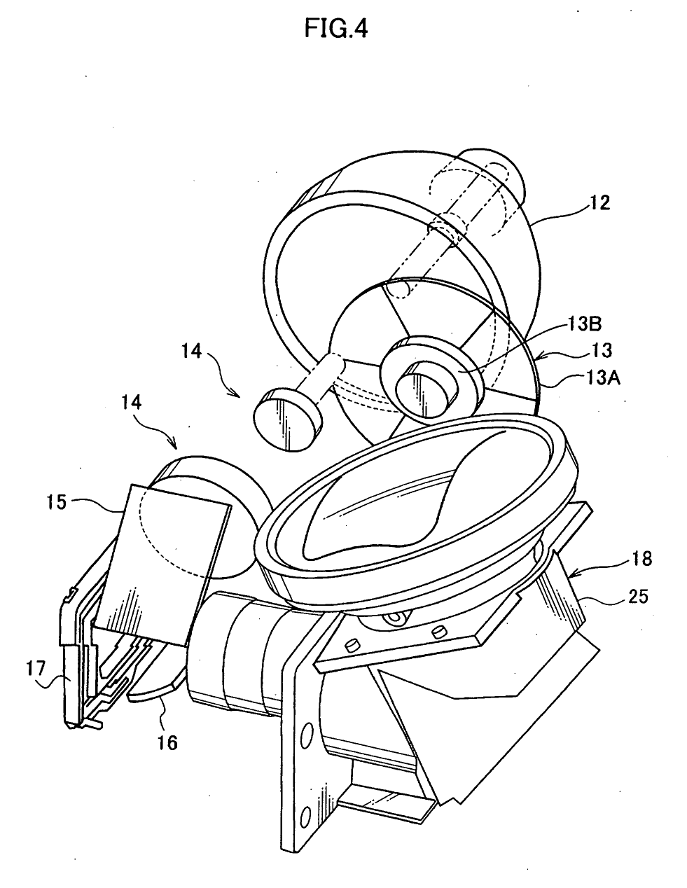

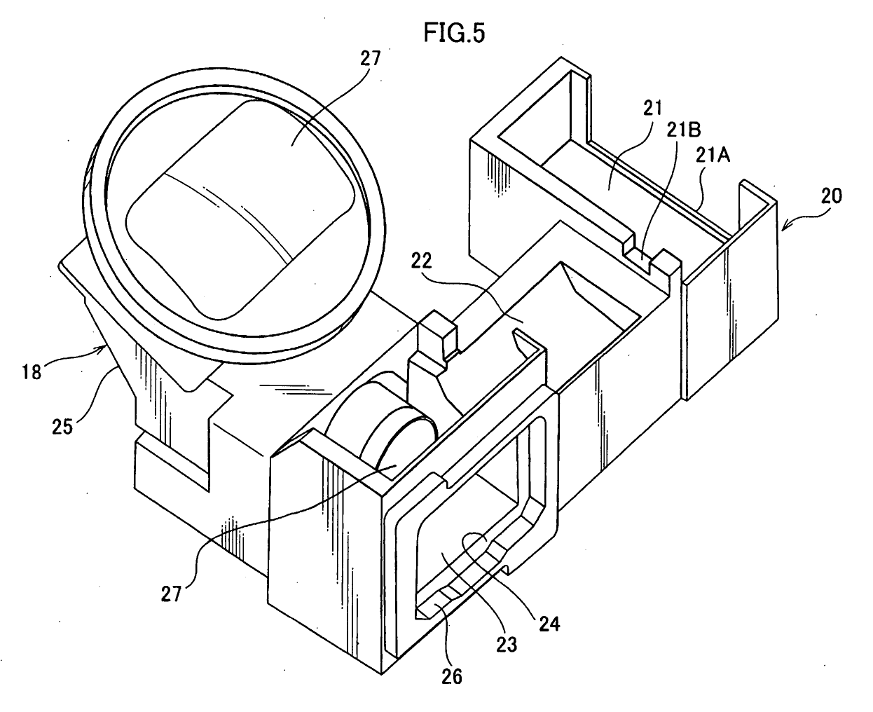

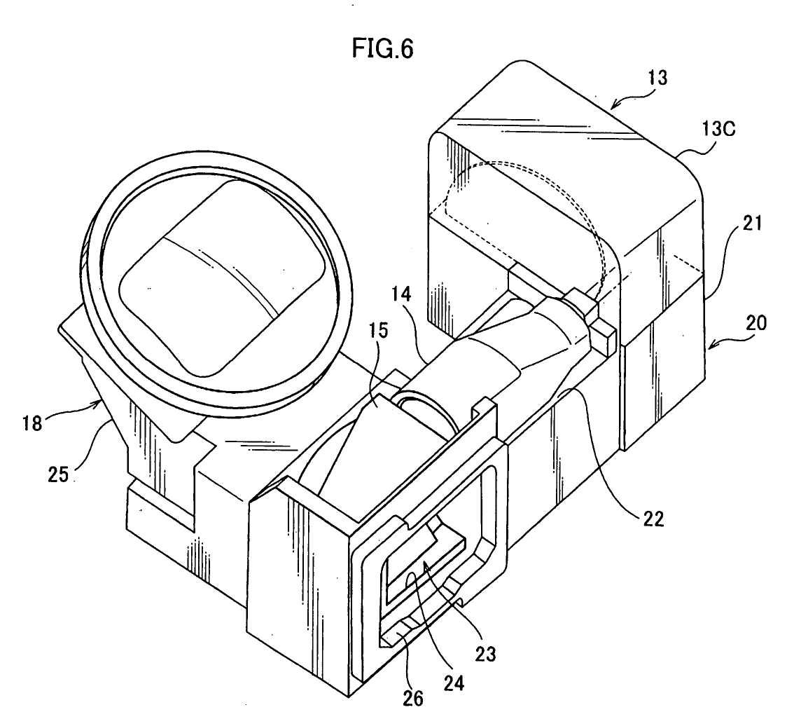

A projection lens unit according to a first embodiment of the present invention will be described with reference to the drawings. FIG. 1 is a perspective view showing the mounting structure of each optical element of the projection lens unit according to the present embodiment, FIG. 3 is a schematic block diagram showing the arrangement state of each optical element of the projection lens unit according to the present embodiment, FIG. 4 is a schematic perspective view showing the arrangement state of each optical element of the projection lens unit according to the present embodiment, FIG. 5 is a perspective view showing a coupling tool of the projection lens unit according to the present embodiment, and FIG. 6 is a perspective view showing a state in which each optical element is mounted in the coupling tool of the projection lens unit according to the present embodiment.

A projection lens unit 11 according to the present embodiment is a unit of a reflection mirror type as shown in FIGS. 3 and 4. The projection lens unit 11 comprises a light source lamp 12, a color wheel 13, a relay lens 14, reflection mirrors 15, 16, a DMD element 17, and a projection lens 18.

The light source lamp 12, the color wheel 13, and the relay lens 14 are elements that form functional light to be irradiated to the DMD element 17 to create an image. The functional light formed in the light source lamp 12, the color wheel 13, and the relay lens 14 is reflected on the two reflection mirrors 15, 16 and is irradiated to the DMD element 17.

The light source lamp 12 outputs white light. The color wheel 13 is a member that adds a color to the white light outputted from the light source lamp 12. The color wheel 13 is mainly composed of a disk-shaped filter plate 13A sectioned into red, blue, yellow, etc., a driving motor 13B rotating the filter plate 13A, and a housing case 13C (refer to FIG. 6) housing the filter plate 13A and the driving motor 13B inside, and is adapted to change the white light into red, blue, yellow, etc. every pre-set time by rotation of the filter plate 13A at a set speed. The relay lens 14 is a member that guides light passed through the color wheel 13 to the reflection mirrors 15, 16. The relay lens 14 has one or more lenses built in a lens barrel.

The reflection mirrors 15, 16 are mirrors that direct the functional light formed in the light source lamp 12, the color wheel 13, and the relay lens 14 to the DMD element 17. The reflection mirrors 15, 16 are located so that the functional light formed in the light source lamp 12, the color wheel 13, and the relay lens 14 is reflected twice on the reflection mirrors 15, 16 and is directed to the DMD element 17 at a set angle.

The DMD element 17 has numerous micromirrors (not shown), each of which arbitrarily turns to display an image on a screen or the like.

The projection lens 18 is a lens that focuses and projects the image light reflected on the DMD element 17 onto the screen or the like. The projection lens 18 is composed of a plurality of lenses that are put together. Further, the projection lens 18 is designed to be a reflective type or a transmissive type depending on the arrangement positions of the light source lamp 12 and the screen or the like. In the example in FIG. 1, it is designed to be a reflective type in which light is reflected obliquely upward by a mirror (not shown).

The light source lamp 12, the color wheel 13, the relay lens 14, the reflection mirrors 15, 16, the DMD element 17, and the projection lens 18 are located at set positions on the light path accurately so that a clear image will be displayed on the screen or the like. To do so, a coupling tool 20 is provided to fix the color wheel 13, the relay lens 14, the reflection mirrors 15, 16, the DMD element 17, and the projection lens 18 integrally in a state where the distances therebetween are accurately supported to set values.

The coupling tool 20 is composed of a color wheel fitting portion 21, a relay lens fitting portion 22, a reflection mirror fitting portion 23, a DMD element mounting portion 24, and a projection lens portion 25, as shown in FIGS. 1, 5 and 6. All of these are configured integrally.

The color wheel fitting portion 21 is adapted to fit and support the color wheel 13. The color wheel fitting portion 21 is formed in a recess shape opened upward and sizes in approximately the same dimensions as the outer dimensions of the housing case 13C of the color wheel 13. This makes the color wheel 13 positioned and fixed accurately. The color wheel fitting portion 21 has an input-side cutout 21A and an output-side cutout 21B. Light from the light source lamp 12 is adapted to pass through these input-side cutout 21A and output-side cutout 21B.

The relay lens fitting portion 22 is adapted to fit and support the relay lens 14. The relay lens fitting portion 22 comprises an arc-shaped recess in which the relay lens 14 is fitted. The relay lens fitting portion 22 sizes in approximately the same dimensions as the outer dimensions of the lens barrel portion of the relay lens 14. Further, the relay lens fitting portion 22 is disposed serially with the color wheel fitting portion 21, and its central axis is provided on the light path from the light source lamp 12 to support the relay lens 14 at an accurate position.

The reflection mirror fitting portion 23 is adapted to support the reflection mirrors 15, 16. The reflection mirror fitting portion 23 is formed in a dent shape as large as a space where the two reflection mirrors 15, 16 can be inserted. The two reflection mirrors 15, 16 are put together integrally in a state of being located at accurate positions on the light path. The integrated two reflection mirrors 15, 16 are adapted to be fitted in the reflection mirror fitting portion 23 and be supported at accurate positions on the light path.

The DMD element mounting portion 24 is adapted to support the DMD element 17. The DMD element mounting portion 24 comprises an opening provided facing to the reflection mirror fitting portion 23. To the DMD element mounting portion 24 is attached a metal plate 26 for reinforcement as needed. The metal plate 26 may be attached to the DMD element mounting portion 24 as a single member or may be integrally attached to the DMD element 17. The DMD element 17 is adapted to be supported at an accurate position on the light path by being mounted to the DMD element mounting portion 24.

The projection lens portion 25 is a lens that projects image light reflected on the DMD element 17 onto a screen (not shown). The projection lens portion 25 has a plurality of lenses 27 and a reflection mirror (not shown). The projection lens portion 25 is integrally provided facing to the reflection mirror fitting portion 23. Specifically, as shown in FIG. 4, the projection lens portion 25 may be formed as a single member and subsequently be fixed by screws facing to the reflection mirror fitting portion 23, or may be entirely formed integrally with the reflection mirror fitting portion 23, etc.

By the above configuration, respective optical elements are disposed on the light path accurately and are fixed integrally in a state where the distances therebetween are accurately supported to set values.

[Operation ]

The projection lens unit 11 configured as above functions as follows.

At the time of assembling the projection lens unit 11, each optical element is built in the coupling tool 20 and is fixed integrally. That is, by building respective optical elements in their own fitting portions and fixing them, respective optical elements are disposed on the light path accurately and are fixed integrally in a state where the distances therebetween are accurately supported to set values.

This projection lens unit 11 is built in a rear projector or a front projector.

Thus, light irradiated from the light source lamp 12 passes through the relay lens 14 and forms into functional light for creating an image, and the functional light is reflected on the two reflection mirrors 15, 16 and is irradiated to the DMD element 17. In the DMD element 17, specific micromirrors corresponding to an image among a number of micromirrors turn, which causes the incident light to be reflected toward the projection lens 18 side as image light.

At this time, since the DMD element 17 and the projection lens 18 are supported accurately by the coupling tool 20 with a set distance, no variation occurs in this distance, and the image light reflected on the DMD element 17 is accurately focused on the screen or the like at the projection lens 18 to display an image.

[Effect ]

Since the DMD element 17, the projection lens 18, and so on are accurately supported with set distances therebetween by using the coupling tool 20, it is possible to restrain variation in the distance between the optical elements such as the DMD element 17, the projection lens 18, and so on. As a result, the distance between the DMD element 17 and the projection lens 18, etc. can be maintained to a set distance accurately, and thus a high-quality image can be displayed on the screen or the like. Also, by mounting the DMD element 17 and the projection lens 18 integrally, the number of parts and the number of production phases can be reduced, and production cost can also be reduced.

### Second Embodiment

Next, a second embodiment of the present invention will be described.

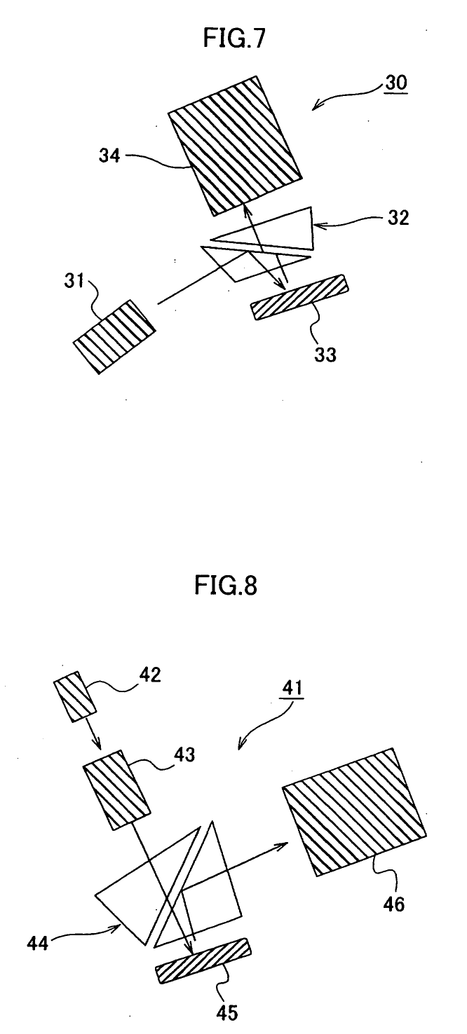

A projection lens unit 30 according to the present embodiment is a unit of a TIR type. The schematic configuration of this projection lens unit 30 (schematic configuration of only optical elements except a coupling tool) is shown in FIG. 7. The projection lens unit 30 is composed of a light source unit 31, a deflection prism 32, a DMD element 33, and a projection lens 34.

The light source unit 31 has a light source lamp, a relay lens (neither shown), etc. built therein. The deflection prism 32 is an optical element that totally reflects functional light from the light source unit 31 and reflects it toward the DMD element 33 side, and causes image light from the DMD element 33 to pass therethrough. The deflection prism 32 consists of two prisms each having a triangular cross-sectional shape. The DMD element 33 is structured similarly to the DMD element 17 in the above first embodiment. The projection lens 34 is structured similarly to the projection lens 18 in the above first embodiment.

A coupling tool is adapted to fix respective optical elements such as the DMD element 33, the projection lens 34, and so on integrally in a state where the distances therebetween are accurately supported to set values. Specifically, it is structured in approximately the same manner as the coupling tool 20 in the first embodiment. Meanwhile, the coupling tool in the present embodiment has a deflection prism fitting portion (not shown) in which the deflection prism 32 is fitted instead of the reflection mirror fitting portion 23 in which the reflection mirrors 15, 16 in the first embodiment are fitted.

The projection lens unit 30 configured as above functions as follows.

At the time of assembling the projection lens unit 30, each optical element is built in the coupling tool and is fixed integrally, as in the first embodiment. That is, by building respective optical elements in their own fitting portions and fixing them, respective optical elements are disposed on the light path accurately and are fixed integrally in a state where the distances therebetween are accurately supported to set values.

This projection lens unit 30 is built in a rear projector or a front projector.

Thus, light irradiated from the light source unit 31 is deflected at the deflection prism 32 and is irradiated to the DMD element 33. In the DMD element 33, specific micromirrors corresponding to an image among a number of micromirrors turn, which causes the incident light to be reflected toward the projection lens 34 side as image light.

At this time, since the DMD element 33 and the projection lens 34 are supported accurately by the coupling tool with a set distance, no variation occurs in this distance, and the image light reflected on the DMD element 33 is accurately focused on the screen or the like at the projection lens 34 to display an image.

At this time, since the DMD element 33, the projection lens 34, and so on are mounted integrally by the coupling tool, the distance between the DMD element 33 and the projection lens 34, etc. can be supported to a set distance accurately, and thus a high-quality image can be displayed on the screen or the like.

### Third Embodiment

Next, a third embodiment of the present invention will be described.

A-projection lens unit 41 according to the present embodiment is a unit of an R-TIR type. This projection lens unit 41 is composed of a light source lamp 42, a relay lens 43, a deflection prism 44, a DMD element 45, and a projection lens 46, as shown in FIG. 8.

The light source lamp 42 and the relay lens 43 are elements that form functional light to be irradiated to the DMD element 45 to create an image. The deflection prism 44 is an optical element that causes functional light from the light source lamp 42 and the relay lens 43 to pass therethrough toward the DMD element 45 side and totally reflects image light from the DMD element 45. The deflection prism 44 consists of two prisms each having a triangular cross-sectional shape. The DMD element 45 is structured similarly to the DMD element 17 in the above first embodiment. The projection lens 46 is structured similarly to the projection lens 18 in the above first embodiment.

A coupling tool is adapted to fix respective optical elements such as the DMD element 45, the projection lens 46, and so on integrally in a state where the distances therebetween are accurately supported to set values. Specifically, it is structured in approximately the same manner as the coupling tool 20 in the first embodiment. Meanwhile, the coupling tool in the present embodiment has a deflection prism fitting portion (not shown) in which the deflection prism 44 is fitted instead of the reflection mirror fitting portion 23 in which the reflection mirrors 15, 16 in the first embodiment are fitted.

The projection lens unit 41 configured as above functions as follows.

At the time of assembling the projection lens unit 41, each optical element is built in the coupling tool and is fixed integrally, as in the first embodiment. That is, by building respective optical elements in their own fitting portions and fixing them, respective optical elements are disposed on the light path accurately and are fixed integrally in a state where the distances therebetween are accurately supported to set values.

This projection lens unit 41 is built in a rear projector or a front projector.

Thus, light irradiated from the light source lamp 42 passes through the deflection prism 44 and is irradiated to the DMD element 45. In the DMD element 45, specific micromirrors corresponding to an image among a number of micromirrors turn, which causes the image light to be reflected toward the deflection prism 44 side. The image light is totally reflected on the deflection prism 44, is directed to the projection lens 46, and is projected onto the screen or the like.

At this time, since the DMD element 45 and the projection lens 46 are supported accurately by the coupling tool with a set distance, no variation occurs in this distance, and the image light reflected on the DMD element 45 is accurately focused on the screen or the like at the projection lens 46 to display an image.

At this time, since the DMD element 45, the projection lens 46, and so on are mounted integrally by the coupling tool, the distance between the DMD element 45 and the projection lens 46, etc. can be supported to a set distance accurately, and thus a high-quality image can be displayed on the screen or the like.

Although, in the above first embodiment, the color wheel 13, the relay lens 14, the reflection mirrors 15, 16, the DMD element 17, and the projection lens 18 are fixed integrally by the coupling tool 20, the light source lamp 12 may also be fixed integrally with the other optical elements. This can also be applied to the second and third embodiments. In these cases, the similar effects to those in the above embodiments can be obtained.

Although, in the above embodiments, each optical element is fixed integrally by the coupling tool, the coupling tool may fix only the above DMD element 17 and the above projection lens 18 integrally in a state where the distance therebetween is accurately supported to a set value. This can also be applied to the second and third embodiments. In these cases, the similar effects to those in the above embodiments can be obtained.

What is claimed is:

1. A projection lens unit in which light from a light source side is reflected on a DMD element and is subsequently projected at a projection lens, comprising:
a coupling tool that fixes said DMD element and said projection lens integrally in a state where the distance therebetween is accurately supported to a set value.

2. The projection lens unit according to claim 1, wherein said coupling tool includes a DMD element mounting portion in which said DMD element is mounted and supported and a projection lens portion in which said projection lens is mounted and supported.

3. The projection lens unit according to claim 1, wherein said coupling tool includes a color wheel fitting portion for positioning and supporting a color wheel, a relay lens fitting portion for positioning and supporting a relay lens, a deflecting means fitting portion for positioning and supporting a deflecting means, a DMD element mounting portion in which said DMD element is mounted and supported, and a projection lens portion in which said projection lens is mounted and supported.

4. The projection lens unit according to claim 3, wherein said deflecting means is a reflection mirror or a deflection prism.
